(19) United States
(12) Patent Application Publication
(10) Pub. No.: US 2003/0028884 A1
(43) Pub. Date: Feb. 6, 2003

(54) Video and digital multimedia aggregator content availability notification system and method

(76) Inventors: William D. Swart, Fairfax, VA (US); John S. McCoskey, Castle Rock, CO (US); Michael L. Asmussen, Oak Hill, VA (US)

Correspondence Address: Dorsey & Whitney LLP, Suite 300 South, 1001 Pennsylvania Avenue, Washington, DC, 20004, US

(21) Appl. No.: 09/977,488

(22) Filed: Oct. 16, 2001

Related U.S. Application Data
(63) Continuation-in-part of application No. 09/920,723, filed on Aug. 3, 2001.

(51) Int. Cl. G06F 3/00; H04N 5/445; H04N 7/00

(52) U.S. Cl. 725/51; 348/461; 725/37; 725/39

(57) ABSTRACT

An aggregator, operating in a digital communications network, includes a request and results processing server, a search engine server coupled to the request and results processing server and a content acquisition server coupled to the request and results processing server. A request and results processing server receives a request for content, the search engine server searches for the content and the content acquisition program acquires content for delivery to the user. The request and results processing server includes a search request processor that receives information related to a user's search request and provides the information to a search results form builder that creates an electronic search request. The search request may be augmented by using a content suggestion engine to add additional search terms and descriptions to the search request. The aggregator may also include a decoder that decodes program content and program metadata from remote sources for storage at the aggregator, and an encoder that encodes content metadata and programs for delivery to the user. The aggregator may also comprise one or more crawlers, such as a content crawler, to look for program content in one or more digital communications networks.

### RELATED APPLICATIONS

This application is a continuation-in-part of patent application Ser. No. 09/920,723, filed Aug. 3, 2001, entitled “Video and Digital Multimedia Aggregator.”

The following U.S. Patents also are incorporated by reference:

U.S. Pat. No. 5,798,785, entitled “Terminal for Suggesting Programs Offered on a Television Program Delivery System;”

U.S. Pat. No. 5,986,690, entitled “Electronic Book Selection and Delivery System;”

The following co-pending U.S. patent applications also are incorporated by reference:

patent application Ser. No. 07/991,074, filed Dec. 9, 1992, entitled “Remote Control for Menu Driven Subscriber Access to Television Programming;”

patent application Ser. No. 08/906,469, filed Aug. 5, 1997, entitled “Reprogrammable Terminal for Suggesting Programs Offered on a Television Program Delivery System;”

patent application Ser. No. 09/191,520, filed Nov. 13, 1998, entitled “Digital Broadcast Program Ordering;”

patent application Ser. No. 09/289,957, filed Apr. 13, 1999, entitled “Electronic Book Alternative Delivery Systems;”

patent application Ser. No. 09/289,956, filed Apr. 13, 1999, entitled “Electronic Book Alternative Delivery Methods;” and

patent application Ser. No. 09/920,615, entitled “Video and Digital Multimedia Aggregator Remote Content Crawler,” and patent application Ser. No. 09/921,057, entitled “Video and Digital Multimedia Aggregator Content Suggestion Engine,” both filed on Aug. 3, 2001.

### TECHNICAL FIELD

The technical field is television program and digital multimedia delivery systems that incorporate intelligent and flexible program search and delivery mechanisms.

### BACKGROUND

Cable television delivery systems greatly expanded the array of programs available to television viewers over that provided by over-the-air broadcast systems. Subsequently, satellite television delivery systems, and in particular, digital satellite broadcast systems further expanded the viewing choices for consumers. In the near future, digital broadcast television systems will provide many more programming choices for consumers.

In addition to television programming delivered through television program delivery systems, other programs and events may be sent to consumers. These other programs and events include streaming video sent over wired and unwired, narrowband to broadband services, digital audio programs, and other multimedia data.

Unfortunately, customers are still limited in their television viewing choices by the local and regional nature of television delivery systems. For example, a broadcaster in Boston may provide programming of local interests to people in Massachusetts while a broadcaster in Seattle may provide different programming to people in the Seattle area. A person in Boston generally cannot access Seattle programming, other than programming that is provided at a national level.

In addition to this local/regional market segregation, many other sources of programming and events may not be available in a specific viewing area. These other sources may include audio programming, streaming video, local or closed circuit television programming (e.g., education television programming provided by a state education department) and other programming.

Even if certain programming is available in a local viewing area, a viewer may not be aware of its existence. This situation may be the result of a large array of available programming coupled with a limited program menu or guide. The program guide may be limited in that not all available programming can be listed, some programming changes occur that are not reflected in the program guide, and errors may exist in the program guide. In addition, the more comprehensive the program guide, the harder it is for the viewer to search and navigate the program guide to find a desired program.

### SUMMARY

The problems noted above are solved by the video and digital multimedia aggregator system and method described herein. Program content can be packaged and delivered by the system, including video, television, radio, audio, multimedia, computer software, and electronic books, or any content that can be delivered in digital format.

The aggregator comprises a request and results processing server, a search engine server coupled to the request and results processing server and a content acquisition server coupled to the request and results processing server. The request and results processing server receives a request for a program, the search engine server searches for the program and the content acquisition server acquires a program for delivery to the user. The request and results processing server includes a search request processor that receives information related to the user's search request and provides the information to a search results form builder that creates an electronic search request. The search request may be augmented by using a content search suggestion engine to add additional search terms and descriptions to the search request. The aggregator may also include a decoder that decodes program content and program metadata from remote sources for storage at the aggregator, and an encoder that encodes content metadata and programs for delivery to the user. The aggregator may also comprise one or more crawlers, such as a content crawler, to look for program content in the digital communications network.

The search engine server searches at least a local content database. The local database comprises at least two file types. A content file includes a complete program content file. For example, the 1997 movie Titanic may exist in the local content database as a complete program content file. The complete program content file may also include a reference content or metadata that contains additional information related to the content. Such additional information in the reference content may include: a program description, including program rating, program description, video clips, program length, format (e.g., 4×3 television or 16×9 movies), and other information; billing information and digital rights management information; viewing statistics, including number of times viewed, dates/times viewed, identity of users viewing the program; advertisement information to allow ads to be inserted during viewing of the program; and other information.

The additional information in the reference file may be provided in whole or in part to the system users. For example, the aggregator may provide a program description and accompanying video clips to selected systems users. The reference file may also be used by the aggregator for system administration purposes. For example, billing and digital rights management information may be used to collect appropriate fees from system users and to provide such collected fees to the entities owning rights in the content.

A remote content crawler continually crawls the digital communication network looking for content to provide to the aggregator. The content provided to the aggregator may be stored in a form of an entire content file. For example, the content may include an entire movie, television program or electronic book. Alternatively, the content provided to the aggregator may be a reference to a content file that is stored at, or that will be available at one of the remote locations. For example, the content may be a reference to a future, scheduled live sports event that will be made available to system users. The sports event may be provided for a one-time fee, as part of a sports package, for which a fee is collected, or as a free event. In the examples discussed above, the content may be stored at the aggregator, and may subsequently be provided to system users. For the example of the live sports event, the aggregator may store the live sports event and may then provide the sports event as a replay, in addition to facilitating live viewing of the sports event.

### DESCRIPTION OF THE DRAWINGS

The detailed description will refer to the following drawings in which like numerals refer to like elements, and in which:

FIG. 1 is a block diagram of primary components of a content search, packaging, and delivery system;

FIG. 2 is a block diagram of the components of the content search, packaging, and delivery system configured to deliver content to a set top terminal;

FIG. 3 is a block diagram of the components of the content search, packaging, and delivery system configured to deliver content to a personal computer terminal;

FIG. 4 is a schematic of the components of the content search, packaging, and delivery system showing subsystems of an aggregator, a user terminal, and a remote content server;

FIG. 5 is a schematic of subsystems of a request and results processing server and components with which the processing server interacts as part of the content search, packaging, and delivery system;

FIG. 6 is a schematic of subsystems of a content acquisition server and components with which the content acquisition server interacts as part of a content search, packaging, and delivery system;

FIG. 7 is a schematic of subsystems of a content delivery server and components with which the content delivery server interacts as part of the content search, packaging, and delivery system;

FIG. 8 is a diagram of a content availability notification architecture as part of the content search, packaging, and delivery system; and

FIG. 9 shows examples of a video pop-up notification window and a video notification icon.

### DETAILED DESCRIPTION

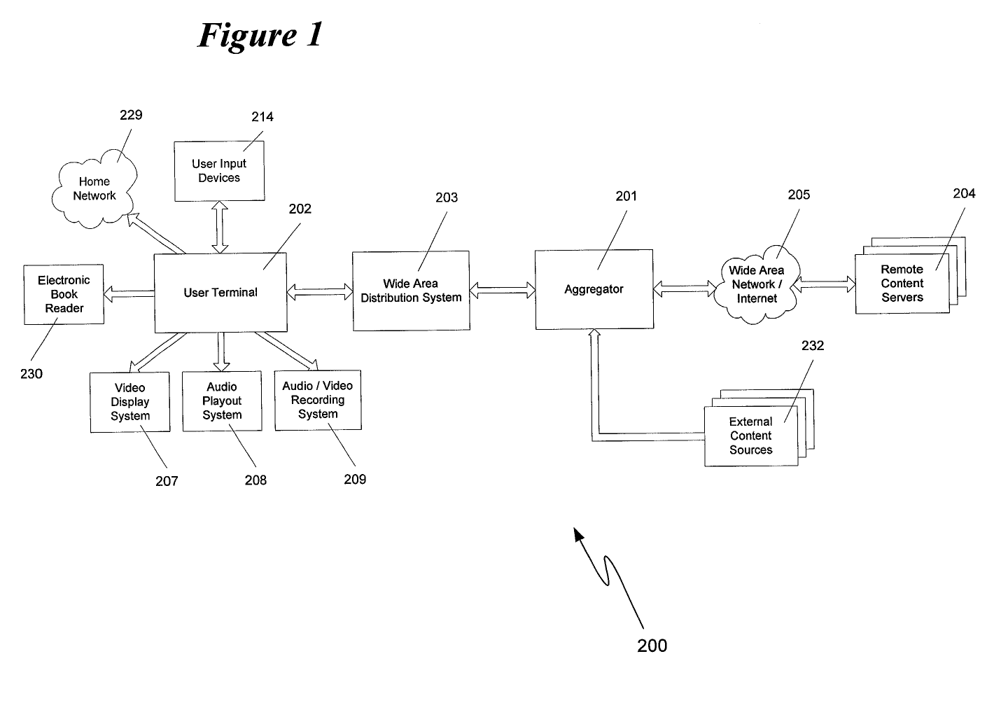

FIG. 1 is a block diagram of a content search, packaging, and delivery system 200. The content to be packaged and delivered by the system 200 includes video, television, radio, audio, multimedia, computer software and electronic books. Components of the system 200 include an aggregator 201 and a user terminal 202, which are connected using a wide area distribution system 203. Other components are remote content servers 204 that exchange data with the aggregator 201 using a wide area network/Internet 205 connection and external content sources 232 that provide other content data to the aggregator 201. The user terminal 202 may incorporate a video display system 207, an audio playout system 208, an audio/video recording system 209, user input devices 214, an electronic book reader 230, and a connection to a home network 229 to interact with other devices in the user's home environment. Alternatively, one or more or all of the video display system 207, the audio playout system 208, the audio/video recording system 209, and the electronic book reader 230 may be separate components that are coupled to the user terminal 202.

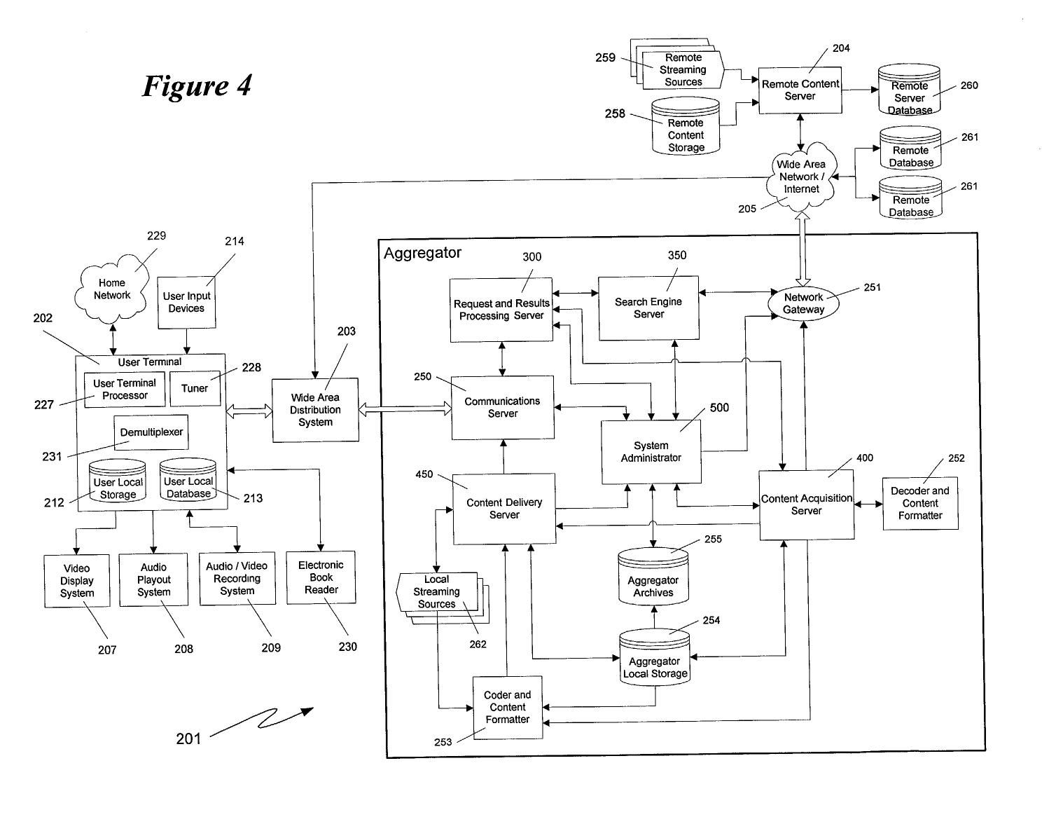

The system 200 allows a user to enter search parameters, such as keywords and category headings, and have the aggregator 201 use these parameters to locate, package, and deliver content to the user terminal 202 from numerous sources. The requests and content deliveries can be sent over communications links including, but not limited to, telephone lines, coaxial cable, fiber-optic cable, wireless connections, satellite networks, terrestrial broadcast systems, wide area networks, the Internet, physical media distribution, and other communication media collectively represented by the wide area distribution system 203. The numerous sources of content are shown in FIG. 4 and include, but are not limited to, an aggregator local storage 254, local streaming sources 262, remote content storage 258, and remote streaming sources 259. In an embodiment, the local streaming sources 262 are comprised of the audio and video channels being delivered using a cable headend system that may house the aggregator 201.

The system 200 will take a user's search request and may perform a search of virtually every active and scheduled radio and television channel in the world, as well as archived sources of video and audio programming such as movies and recorded audio sources, and sources of other multimedia, software, and electronic book content. In an embodiment, the system 200 will also search Internet Web sites and other online databases. The user will then be able to select programming or other content for download based on the search results. In an embodiment, the download, or delivery, process can be fulfilled by making the content available on a specific channel of a cable television or other broadcast system, or by transmitting the content using a digital communications protocol, such as the Internet standard TCP/IP, for example. In addition, the content search, packaging, and delivery system 200 is capable of formulating and presenting a list of suggested content based on an analysis of the user's current search parameters, stored information about previous searches and previously selected content downloads and other user-specific or related information. The system 200 is also capable of notifying a user prior to the start time of selected programming and availability of other content using such notification as an electronic mail message and/or an on-screen message indicating that the scheduled program will be broadcast at a specified time. The system 200 may support one or more digital rights management (DRM) systems to track the copyrights and usage rights associated with downloaded content and bill the user's account as appropriate and provide any license and usage fees to the content provider. The system 200 may implement a users' privacy protection scheme allowing users to control what information is gathered, limit what is done with that information, and review and delete information in the user's profile if desired.

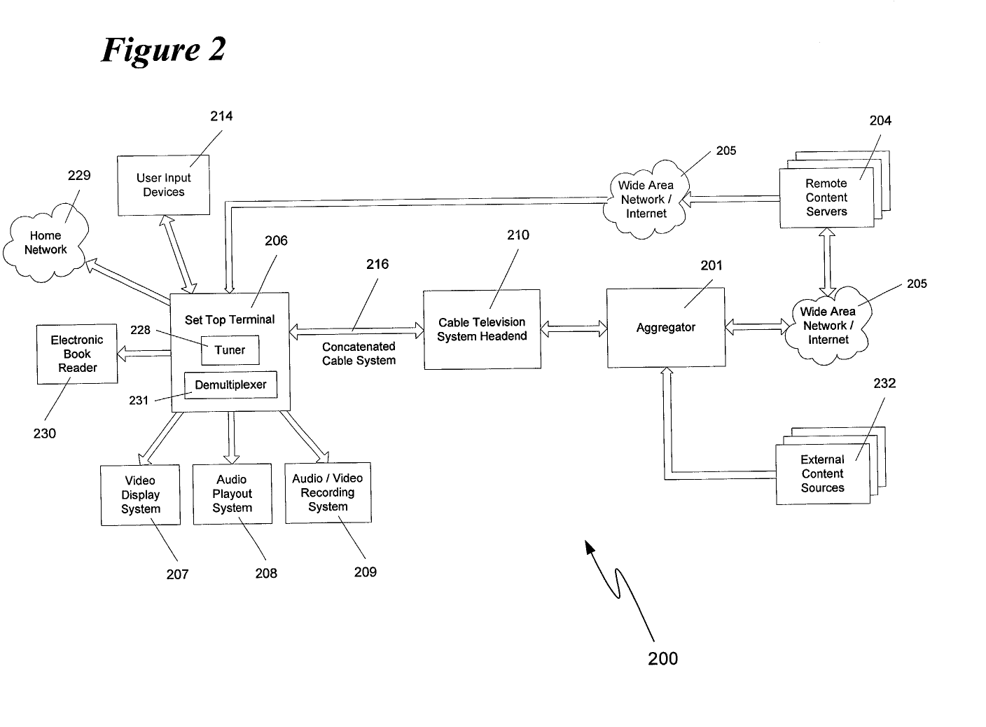

An overview of an embodiment of the system 200 is shown in FIG. 2 where the user terminal 202 is a set top terminal 206 that communicates with the aggregator 201 through a cable television system headend 210, thereby making use of the cable television system headend 210 high bandwidth concatenated cable system 216. Further, the set top terminal 206 system may include a tuner 228, a demultiplexer 231, a video display system 207, an audio playout system 208, an audio/video recording system 209, user input devices 214, an electronic book reader 230, and a connection to the user's home network 229. These components may be used to tune, select, view, listen to, and store audio and video programming and other content delivered by the search, packaging, and delivery system 200. FIG. 2 also shows a communications path from one or more remote content servers 204 through the wide area network/Internet 205 directly to the set top terminal 206, which bypasses the aggregator 201 and cable television system headend 210. This path may be used in the case where the requested content is available in the required format from the remote content server 204 and is authorized for direct delivery to the user. In an alternative embodiment, the aggregator 201 is collocated with the cable television system headend 210 that is acting as the wide area distribution system 203 as is the case when a cable television system is also serving as the user's Internet service provider.

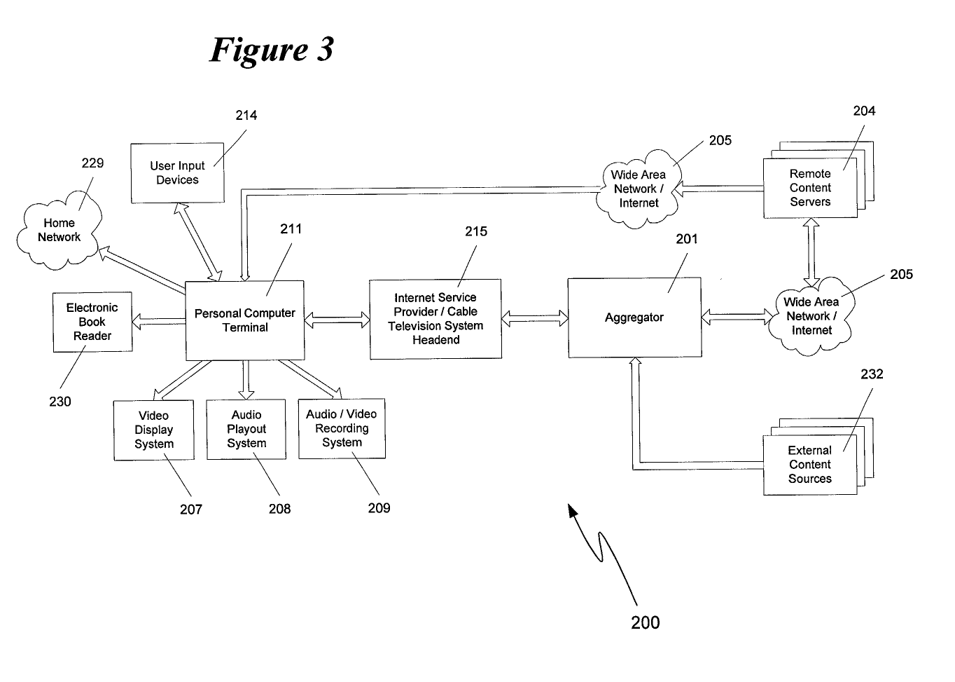

An overview of another embodiment of the system 200 is shown in FIG. 3, where the user terminal 202 is a personal computer terminal 211 that communicates with the aggregator 201 through an Internet service provider/cable television system headend 215. In this case, the content may be delivered by a cable headend that is operating as an Internet service provider (ISP). The personal computer terminal 211 also may include a video display system 207, an audio playout system 208, an audio/video recording system 209, user input devices 214, an electronic book reader 230, and a connection to the home network 229. A communications path also exists from one or more remote content servers 204 through the wide area network/Internet 205 directly to the personal computer terminal 211, which bypasses the aggregator 201 and the Internet service provider/cable television system headend 215 in the case where requested content is in the required format and is authorized for direct delivery to the user.

The user can receive video and audio programs (i.e., the content) in a number of different ways. First, the tuner 228 in the user terminal 202, shown in FIG. 2, can simply tune to the desired program, or the demultiplexer 231 can select a program from a digital multiplex, thereby displaying the program at the appropriate time. However, the desired program may not be broadcast by the user's cable television system headend 210, or the user would like to watch a program supplied by the local headend, but not subscribed to by the user, e.g., a boxing match broadcast by a premium channel that the user does not ordinarily receive. In these examples, the program can be delivered to the user by the aggregator 201 using the telephone lines, fiber-optic transmission lines, or other communication media, or using the cable television system headend 210. In an embodiment, the aggregator 201 can supply the desired program to the user by pulling programs from program delivery systems in the United States and abroad and delivering the program to system users. Therefore, a user can have access to programs outside the user's immediate viewing area.

FIG. 4 shows an embodiment of the system 200 and system components in more detail. At a user's location, the user terminal 202 includes a tuner 228, a demultiplexer 231, a user terminal processor 227, user local storage 212 and user local database 213. Coupled to the user terminal 202 may be user input devices 214, a video display system 207, an audio playout system 208, an audio/video recording system 209, an electronic book reader 230, and a connection to the home network 229.

The user terminal 202 is coupled through the wide area distribution system 203 to the aggregator 201 and further through the wide area network/Internet 205 to remote program sources. The remote program sources include remote streaming sources 259 and remote central storage 258. The remote program sources also include remote databases 261 and, through the remote content server 204, a remote server database 260.

The aggregator 201 may include a communications server 250 that communicates with the user terminal 202 through the wide area distribution system 203. The communications server 250 receives inputs from a request and results processing server 300, a content delivery server 450 and a system administrator 500. The content delivery server 450 receives inputs from a coder and content formatter 253 and a content acquisition server 400. The content delivery server 450 also accesses an aggregator local storage 254 and local streaming sources 262. Finally, the content delivery server 450 provides an output to the system administrator 500.

The coder and content formatter 253 receives inputs from the content acquisition server 400, the aggregator local storage 254 and local streaming sources 262. The system administrator 500 receives inputs from the content and delivery server 450, and communicates with the content acquisition server 400, the request and results processing server 300, a search engine server 350 and aggregator archives 255. A decoder and content formatter 252 is coupled to the content acquisition server 400. Finally, a network gateway 251 couples components of the aggregator 201 with the remote content server 204 through the wide area network/Internet 205.

Content received at the aggregator 201 may be input to the formatter 253. The formatter 253 reformats all input content into a format that is readily received by one or more user terminals 202 operably connected to the delivery system 200. In addition, the formatter 253 can store full or partial copies of content in compressed form in the aggregator local storage 254. Furthermore, the aggregator 201 can provide real-time delivery of certain content, such as a boxing match. In an embodiment, if a large number of users want a particular live program, then the cable television system headend 210 can broadcast the program on a particular channel available to all the requestors instead of broadcasting the program to each individual user over the wide area distribution system 203. See U.S. patent application Ser. No. 09/191,520, entitled Digital Broadcast Program Ordering, hereby incorporated by reference, for additional details of broadcast program delivery.

The aggregator 201 can also implement a screening process for limiting the number of programs captured to those programs with a viewing audience above a predetermined threshold. In effect, the aggregator 201 contains a filter that will pass only programs meeting the predetermined selection criteria. The filter may include programming that screens the content to reject specific items, such as adult content, for example.

The system administrator 500 records what fees should be paid and to whom. For example, the aggregator 201 will determine to whom any copyright or other fees should be paid when a program is broadcast.

The user terminal 202 may be a television, a set top terminal 206, a personal computer terminal 211 (see FIG. 3), or any device capable of receiving digital or analog data, or some combination thereof. The user terminal 202 may be equipped with user input devices 214 that communicate search criteria to the system 200 as well as navigate through the user terminal menu system and control the user terminal's other various functions. The user local storage 212 is used to store and archive content onto one or more removable and/or non-removable storage devices or media for later access. Removable storage media may include, but is not limited to, magnetic tape, magnetic disks, optical disks and modules, and electronic memory cartridges. The user local database 213 is the repository of all relevant information about a user's profile and account. The user profile and account information includes, but is not limited to, user name, password, personal information that the user has authorized for storage, billing information, other users allowed access to the account, past search criteria, past content download information, and library information about stored content. As a consumer protection, the user terminal 202 may enable the account user to view the information stored in the user local database 213 and modify certain data fields and select which data fields may be reported to a main system database within the aggregator 201. Certain fields including, but not limited to, account numbers and billing information may not be allowed this level of user access.

The user terminal processor 227 may include a central processing unit and all associated hardware, software, and firmware modules to perform all operations within the user terminal 202. These operations include, but are not limited to, managing communications with the aggregator 201 and other networked devices, processing search and download requests, displaying search and download results, managing and controlling communications with the user local storage 212 and the user local database 213, responding to user interaction with presentation of graphical user interface (GUI) menus, playing out selected programming content using various audio and video output devices, implementing the user's part of the digital rights management schema, and administering the user's account and billing. The tuner 228 and the demultiplexer 231 are used to select an audio/video channel for playout from the channels available on one or more cable television system 216 and/or other delivery systems such as a satellite system and/or off-air broadcast receiver. The term “off-air” is used to indicate that the broadcast signal can be received over the public airwaves with the use of an appropriate antenna.

In an embodiment, the user terminal 202 may incorporate selected features of the aggregator 201. For example, the user terminal 202 may include a small metadata crawler, an aggregator, and program content and program metadata storage.

The user terminal 202 communicates with the aggregator 201 using the wide area distribution system 203. Within the aggregator 201, the communications server 250 acts as the interface point to the wide area distribution system 203 for the purpose of managing primary communications to system users. The communications server 250 routes incoming user requests and associated user information to the request and results processing server 300, routes search results and content downloads through the wide area distribution system 203 to end users, and routes billing information to the end users from a customer billing server within the system administrator 500. The request and results processing server 300 performs the basic processing and routing related to user search requests, content download requests, administrative information requests, search results, related content suggestions, and programming notification.

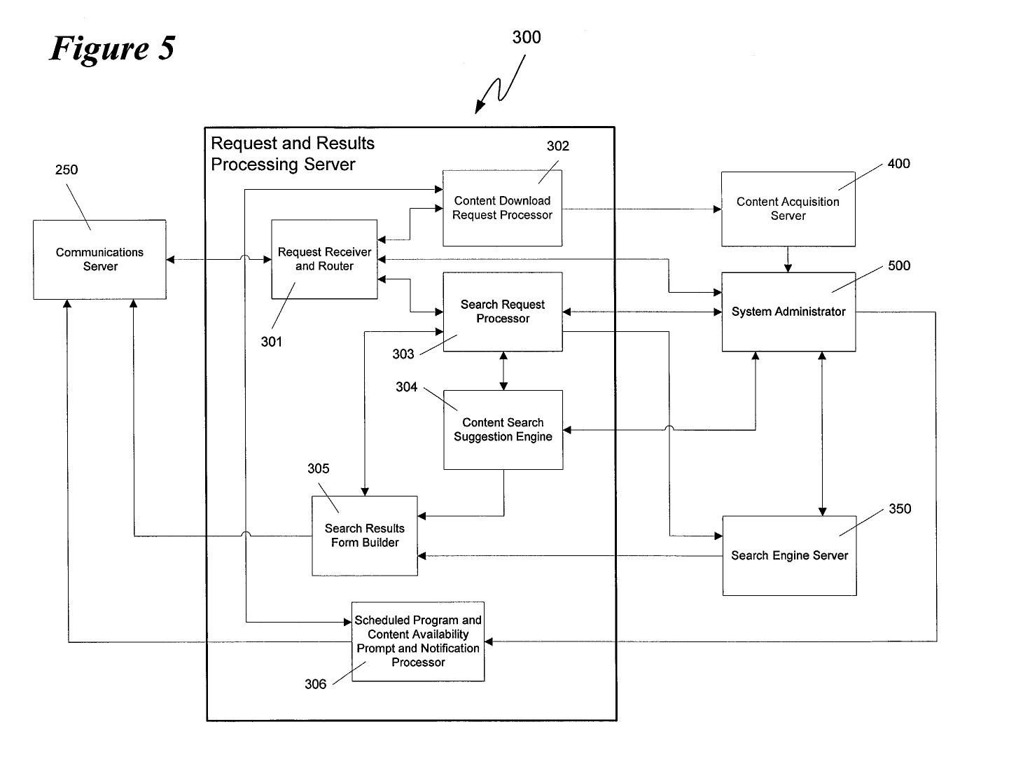

FIG. 5 shows individual subsystems of the request and results processing server 300. The types of requests from a system user include, but are not limited to, programming and other content search requests, content download requests based on results of an earlier search, and administrative information requests. Requests for administrative information may be automatically generated by the user terminal 202 or may be manually initiated by the system user. When an administrative request is received, a request receiver and router 301 opens a dialog with a database administrator (not shown in FIG. 4) within the system administrator 500, retrieves the requested system user's administrative data, and routes the data through the communications server 250 to the user terminal 202. Search requests and content download requests are routed to a search request processor 303 and a content download request processor 302, respectively. The processors 302 and 303 open a dialog with the database administrator and verify that the user's request is authorized. If the user's request is not authorized, the processor (302 or 303) sends a message to the user through the request receiver and router 301 and the communications server 250 informing the user that the request is denied. The processor (302 or 303) then logs the event with the system administrator 500. If the request is authorized, the processor (302 or 303) formats the request as necessary and routes content download requests to the content acquisition server 400 and search requests to the search engine server 350.

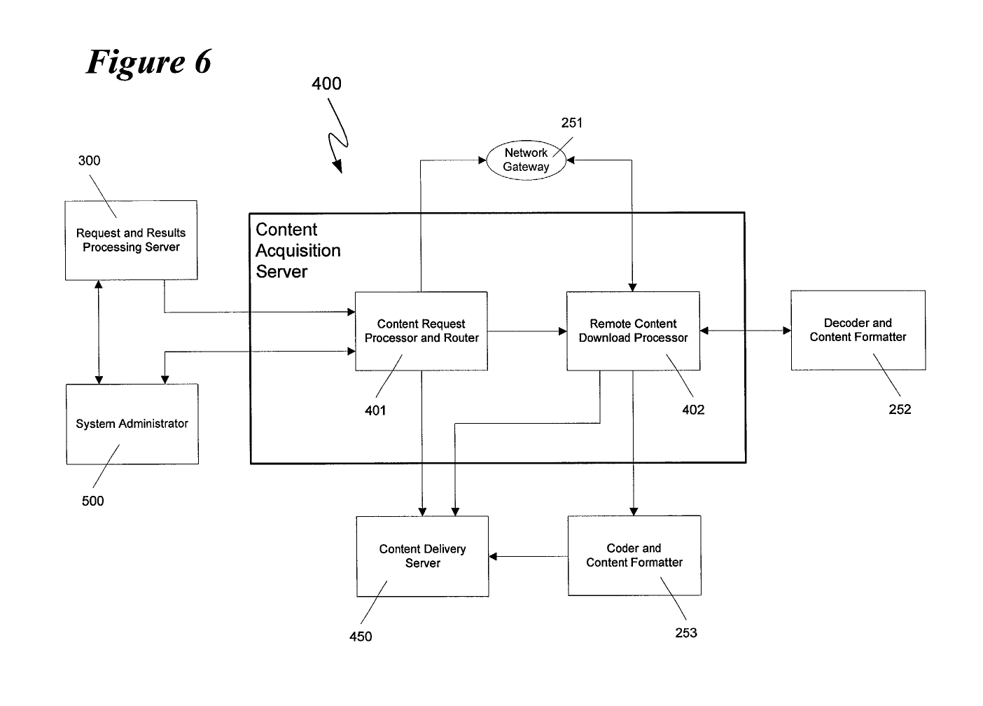

In addition to searching for content containing criteria entered by a system user, a content search suggestion engine 304, in conjunction with the search engine server 350 will be able to suggest content to the user that is related in various ways, such as by category or theme. The content search suggestion engine 304 is shown in detail in FIG. 6. For example, if a user wishes to see programs about Titanic, the content search suggestion engine 304 may, in addition to suggesting programs about Titanic, suggest or inform the user of programs and other content such as electronic books about ships other than Titanic. Likewise, if the search criteria include Johnny Weismuller, an actor who starred in Tarzan movies, the content search suggestion engine 304 might suggest programs and other content about Tarzan featuring someone other than Johnny Weismuller. Furthermore, the content search suggestion engine 304 may suggest programs for viewing based on past search criteria entered by the user as well as information on content the user has actually downloaded. For example, if the search criteria includes Johnny Weismuller and the user has searched and/or downloaded numerous sports-related programming in the past, the content search suggestion engine 304 may suggest programming and other content including swimming competitions and sports history and biography programming as well as Tarzan movies and other content directly related to Johnny Weismuller such as the Jungle Patrol television series. If the user searched for and received Tarzan movies, the content search suggestion engine 304 might suggest electronic books by Edgar Rice Burroughs. Such electronic books could then be downloaded to the user terminal 202 using the wide area network/Intranet 205 bypassing the aggregator 201, or could be compiled at the aggregator 201 for delivery to the user terminal 202. Electronic book delivery systems are described in U.S. Pat. No. 5,986,690, entitled “Electronic Book Selection and Delivery System,” to Hendricks, and in co-pending patent application Ser. No. 09/289,957, entitled “Electronic Book Alternative Delivery Systems,” and Ser. No. 09/289,956, entitled “Electronic Book Alternative Delivery Methods,” all of which are hereby incorporated by reference. The content suggestion function of the aggregator is described in more detail in co-pending patent applications entitled “Video and Digital Multimedia Aggregator” and patent application entitled “Video and Digital Multimedia Aggregator Content Suggestion Engine,” filed on Aug. 3, 2001, which are incorporated by reference.

Returning to FIG. 5, all search results, based on user search criteria and suggested search criteria, may be forwarded by the search engine server 350 and then to the search results form builder 305 within the request and results processing server 300. The search results form builder 305 formats the results for transmission through the communications server 250 to the user terminal 202. The search results form builder 305 takes prioritized lists of user search results and suggested search results and populates a search results form with programming, scheduling and availability information. The request and results processing server 300 then encrypts and forwards the search results form 674 through the communications server 250 to the user terminal 202. At the user terminal 202, the search results form 674 is decrypted and stored in the user local database 213 and a prompt is displayed that allows the user to display the returned results on the video display system 207 or the electronic book reader 230. For search requests, the search engine server 350 returns a data package to the request and results processing server 300 that contains scheduling, availability, and descriptive information about all content entries that have been determined to satisfy the search criteria.

The search results can then be displayed on the user's video display system 207 in various formats including, but not limited to, a hierarchical listing based on relevance to search criteria and a display similar to an electronic program guide based on time of availability and content source. The user will be able to select from the various results display formats and have the results data be reformatted upon request. In an embodiment, the user may be able to select one of the search criteria or an attribute of the programming and the results will be sorted based on that selection. For example, if numerous program types are returned, the user can select “documentaries” and the results will be listed with documentary programs occurring first. The results display will also indicate whether a particular programming choice is a result of the user-defined search criteria or was a result of the system's capability to suggest content. The user will have the ability to display only results from the user search, only results from the suggested content search, or both. In an embodiment, the entire menu system can be implemented using audible prompts and lists in order to accommodate users with visual impairments. In such a scenario, input methods can be by voice recognition, tactile recognition such as a remote control equipped with a Braille character input pad, or a combination of these methods.

As shown in FIG. 4, the network gateway 251 serves as the communications system between the aggregator 201 and the wide area network/Internet 205, and hence to one or more remote content servers 204. The network gateway 251 may support any protocol in widespread use for connection to the wide area network/Internet 205 and may also serve as a security firewall between the aggregator 201 and the wide area network/Internet 205. The network gateway 251 will route search and content download information from the aggregator 201 to one or more remote content servers 204 and route search results and content from the remote content server 204 and other Internet sources back to the aggregator 201.

The content acquisition server 400, as shown in detail in FIG. 6, receives content download requests from the request and results processing server 300. The content acquisition server 400 includes a content request processor and router 401 and a remote content download processor 402. A download request is made by the user for content selections from sources including, but not limited to, earlier programming searches, recurring scheduled events, an electronic program guide, lists of electronic books and computer software, advertisements, promotions, and affiliated Internet websites. In general, a download request will be accompanied by data indicating the source of the content and whether the content is local or remote. Requests for content that is available only from a remote site may be routed to the network gateway 251 and then to the appropriate remote source. Remote sources include, but are not limited to, the remote content storage 258 and the remote streaming sources 259 shown in FIG. 4. The remote content server 204 verifies the request and returns the content through the wide area network/Internet 205. If the programming content is in the appropriate format and is authorized for direct delivery to the user, the content may be routed through the wide area network/Internet 205 and the wide area distribution system 203 directly to the user terminal 202. During this transfer, administrative data pertaining to billing and verification of delivery may be sent back to the aggregator 201.

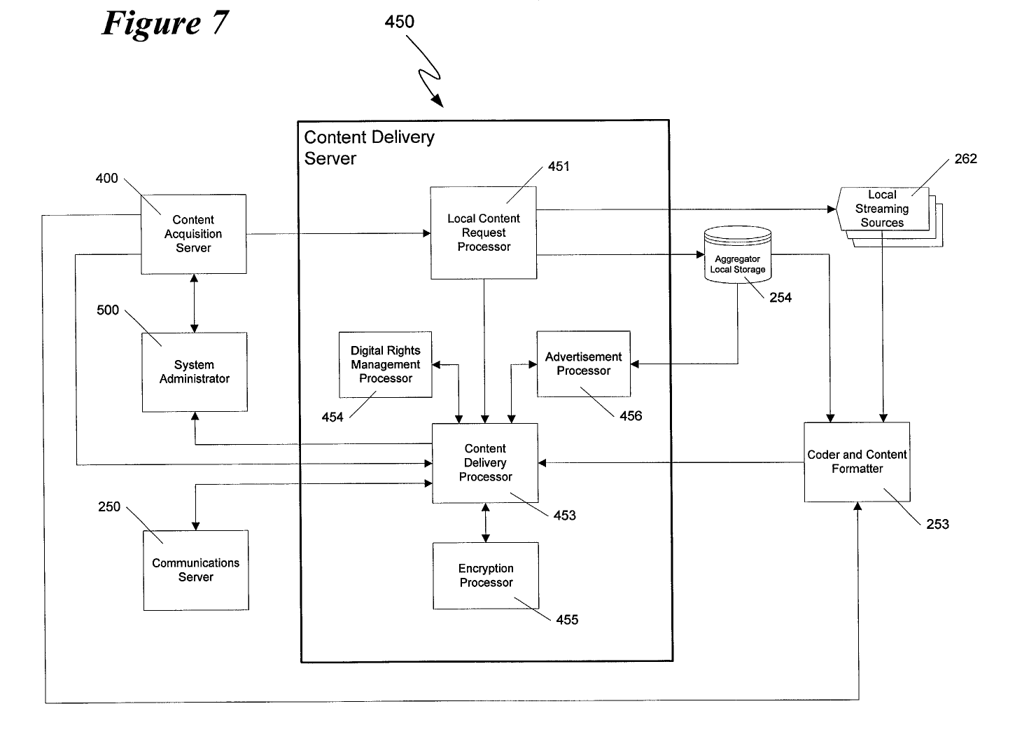

Programming that is not formatted and authorized for direct delivery from a remote source may be transmitted through the network gateway 251 to the remote content download processor 402 contained within the content acquisition server 400. The remote content download processor 402 buffers or caches the programming content while managing the download connection to the remote source. The programming content is then routed to the decoder and content formatter 252, which may be capable of decoding various industry formats and compression schemes and may reformat and encode the decoded data and associated metadata into one or more preferred content formats for delivery and for local storage. The processed programming content, along with user identification and routing data, is then routed to the content delivery server 450, which then manages the delivery of the content through the communications server 250 and wide area distribution system 203 to the user terminal 202. The content delivery server 450 is shown in detail in FIG. 7.

Requests for programming available from a local source are routed directly to a local content request processor 451 within the content delivery server 450. The local content request processor 451 initiates delivery of content from local sources including, but not limited to, the aggregator local storage 254 and aggregator local streaming sources 262, and routes the content to the coder and file formatter 253. In an embodiment, the local streaming sources 262 can include any of the cable television channels available at the cable television system headend 210 housing the aggregator 201. If the programming content is not already in the user-requested format and coding scheme, the coder and content formatter 253 (see FIG. 4) performs content formatting and coding of the programming for delivery to the user. The content is then forwarded to a content delivery processor 453, which manages the delivery of the content through the communications server 250 and wide area distribution system 203 to the user terminal 202.

During the content acquisition and delivery process, the content delivery processor 453 may oversee and validate that the delivered programming content matches the original content download request. This may be done by receiving program and user metadata from the content acquisition server 400 through the local content request processor 451 and comparing the received data to the metadata of the actual requested content and the actual delivered content as received during the program request and download process. A confirmation may then be logged with the system administrator 500. In an embodiment, based on user information and content metadata, the content delivery processor 453 may command an advertisement processor 456 to insert specific advertising into certain programming content as it is delivered to a system user. The advertising can be retrieved from the aggregator local storage 254 or can already be resident at the user terminal 202. Methods for targeting advertisements to users are described in co-pending patent applications Ser. No. 09/054,419, entitled “Targeted Advertising Using Television Delivery Systems,” and Ser. No. 08/160,280, entitled “Method and Apparatus for Targeted Advertising,” both of which are hereby incorporated by reference. Confirmation of the programming delivery is also sent to the database administrator for logging into the aggregator local database (not shown in FIG. 4) within the system administrator 500.

Similarly, if content is copyright protected and the user is granted certain rights and denied others for use of copyright protected content, the content delivery processor 453 may command a digital rights management processor 454 to implement a digital rights management (DRM) scheme. The DRM scheme controls how digital content is used, including, but not limited to, whether or not the content can be stored on the user terminal 202, copied to another system, forwarded to another user, transferred to removable media, or translated into a different digital file format or coding scheme. The DRM scheme may be able to make use of digital encryption technology to enforce copyright protection if necessary. When this is the case, the digital rights management processor 454 will command the content delivery processor 453 to route the subject programming content along with encryption data to an encryption processor 455. The encryption processor 455 encrypts the programming content and returns the content to the content delivery processor 453 for transmission to the end user. Under this type of scenario, the authorized user terminal 202 will possess the necessary information to decrypt and output the programming content. The user terminal 202 will also contain the necessary information to enforce any DRM scheme that has been applied to a particular piece of content.

Upon successful delivery of the requested programming, the content delivery server 450 logs the results with a customer billing server and content fee and copyright billing server (not shown in FIG. 4) within the system administrator 500. The customer billing server determines if the content delivery requires additional charges to the customer's account and enters this into the billing record and logs it with a database administrator (not shown in FIG. 4) within the system administrator. The system administrator is described in more detail in co-pending patent application Ser. No. 09/920,723 entitled “Video and Digital Multimedia Aggregator,” filed on Aug. 3, 2001, which is incorporated by reference.

The system user can initiate content search requests by entering several different types of search criteria using several different options of input device or method. Search criteria can be entered via keywords that relate to certain aspects of programming content including, but not limited to, subject, author, title, cast members or performers, director, and/or content description. A search can be based on program type or format including, but not limited to, movies, television series, documentaries, sports programs, talk radio, and music radio. The user may input search criteria based on subject categories including, but not limited to, action, drama, history, educational, juvenile, adult, current events, nature, live events, and music categories such as classical, jazz, rock, consumer affairs, political content, and geographically specific content. Search criteria can also be entered based on time of day, channel, and/or content provider. The user may also input free form questions using plain speech patterns. In any case, the different search criteria can be used separately or in conjunction with one another to refine a content search. An example might be the entry of “Titanic” as a keyword, “Documentary” for program type, and the free form question “What company built Titanic?”.

The user can interact with the user terminal 202 to input search parameters using one or more of several user input devices 214 including, but not limited to, those shown in FIG. 12. The user input device 214 includes a keyboard 220, a keypad 221, a mouse or joystick 222, a handheld computer 223, a touch screen tablet 224, a handheld remote control 225, a user terminal voice recognition system 219, an input device voice recognition system 226, and an electronic book reader 230.

Since programming content can be delivered in more than one way, the user may also consume the programming in more than one way. Audio and/or video content may be viewed and/or listened to concurrently with the delivery in the case of a broadcast delivery over the cable television system as well as during an Internet delivery of a data stream or file that contains the programming. The user can also store the content as the content is delivered, whether or not the user consumes the content during the delivery, allowing for non-linear playback of content at the user terminal 202 either during delivery or at a later time. Non-linear playback refers to the ability of a user to stop, start, pause, rewind, slowdown, and speedup the playout of a piece of video or audio content. In an embodiment, programming may be delivered from the system 200 in less time or more time than it would take to consume the programming and is saved in user local storage 212 for use at any time thereafter. In the case of a real-time broadcast, the storage method may be onto magnetic tape using an audio/video recording system 209 such as a video cassette recorder, or into user local storage 212 as a digital file such as onto a computer hard disk drive or other digital data storage medium. Once the user has numerous programs stored in the user local storage 212, the user terminal 202 will provide the ability for the user to manage content storage and organization through a series of simple GUIs approximating an audio-video library collection. Storage management may also be automated using either user-defined or pre-set rules, or both. (See DAVIC 1.5 Specifications, TV Anytime and TV Anywhere, Revision 6.0; copyright Digital Audio-Visual Council (DAVIC), hereby incorporated by reference, for more detail about concurrent viewing and storing, non-linear playback, non-real-time delivery, and content storage and management.)

In an embodiment, the user terminal 202, whether it is comprised of a set top terminal 206, a personal computer terminal 211, or some combination thereof, is integrated into a home network 229 serving the user's home. This will enable the consumption of programming content at numerous nodes in the home which may consist of auxiliary user terminals and/or personal computers with various combinations of video display system 207, audio playout system 208, and audio/video recording system 209. The primary user terminal 202 can route programming search and download requests from other network nodes and route subsequent downloaded programming to the requesting node either an a baseband video network or a digital data network such as an Ethernet network. Auxiliary nodes may also have a combination of user input devices 214 to control the system and initiate programming requests and downloads. In an embodiment, a handheld remote control 225 using wireless radio frequency transmission may control the primary user terminal 202 from a remote location to deliver programming to a remote video display system 207.

Once a download request has been processed and authorized, the content download request process creates either an authorized remote download request form or an authorized local download request form and forwards the authorized download request to the content delivery server 450, which fulfills delivery of the content. The content delivery method is described in more detail in co-pending patent application entitled “Video and Digital Multimedia Aggregator Acquisition and Delivery System and Method,” filed on Oct. 10, 2001, which is incorporated by reference. As an authorized remote download request form or an authorized local download request form is received, the content delivery server 450 determines if the request is local or remote, and routes the request form appropriately.

Prior to content delivery, the programming content may be processed by the coder and content formatter 253 if required to deliver the content in an appropriate digital coding scheme, compression, and file format to the user. The coder and content formatter 253 employs digital compression techniques to increase existing transmission capacity. A number of digital compression algorithms currently exist or may be developed in the future that can achieve the resultant increase in capacity and improved signal quality desired for the system 200. The algorithms generally use one or more of three basic digital compression techniques: (1) within-frame (intraframe) compression, (2) frame-to-frame (interframe) compression, and (3) within carrier compression or a combination of two or more techniques. The coder and content formatter 253 of the content search, packaging, and delivery system 200 may be able to use any one or combination of two or more of these techniques in addition to being able to have its capabilities modularly expanded to include any emerging and future techniques that are determined to be desirable.

In an embodiment, although a single digital compression standard may be used for the delivery system 200, different levels of compression can be utilized when delivering programs to a user requesting a particular program. For example, if the program is sent out using an HDTV format, then less compression is used as opposed to sending out the program using a standard video format. The reason is that the HDTV format requires more digital data per portion of content. Since the HDTV format requires more digital data, it will also require more bandwidth to transmit, possibly increasing the cost of delivery. Therefore, the quality of the video delivered may be a variable in the fees charged to users of the system 200.

For programming download requests that may be fulfilled from remote content sources, the content acquisition server 400 may submit scheduling and availability information about the selected content to the database administrator (not shown in FIG. 4) within the system administrator 500. For programming download requests that may be fulfilled from local content sources, the content delivery server 450 may submit scheduling and availability information about the selected content to the database administrator within the system administrator 500. The database administrator may then log the information and the system administrator 500 may route the content scheduling and availability information to a content availability notification processor 306 within the request and results processing server 300 (see FIG. 5). The content availability notification processor 306 may then initiate a form of prompt and/or notification to the user that the requested content is available at a particular time. This notification can be in various forms including, but not limited to, an on-screen pop-up window or icon, audible notification, e-mail notification, instant text message, pager and/or other wireless device message, and automated telephone notification. The exact form and timing of the prompt and/or notification may be customized by the user and may be based on whether the content is scheduled, continuously broadcast, stored, or available any time for download. In an embodiment, when a selected program is about to be broadcast or made available for viewing on television, a prompt will be sent by the server 300 notifying the user when the program is about to air. In the case of an on-screen prompt, a mechanism may be provided for enabling the user to hyperlink to the selected program from the prompt. Requested content may be available at a particular time, as may be the case with scheduled programming content, or may be available immediately, as may be the case with stored content such as audio/video programming, computer software, electronic books and other text files.

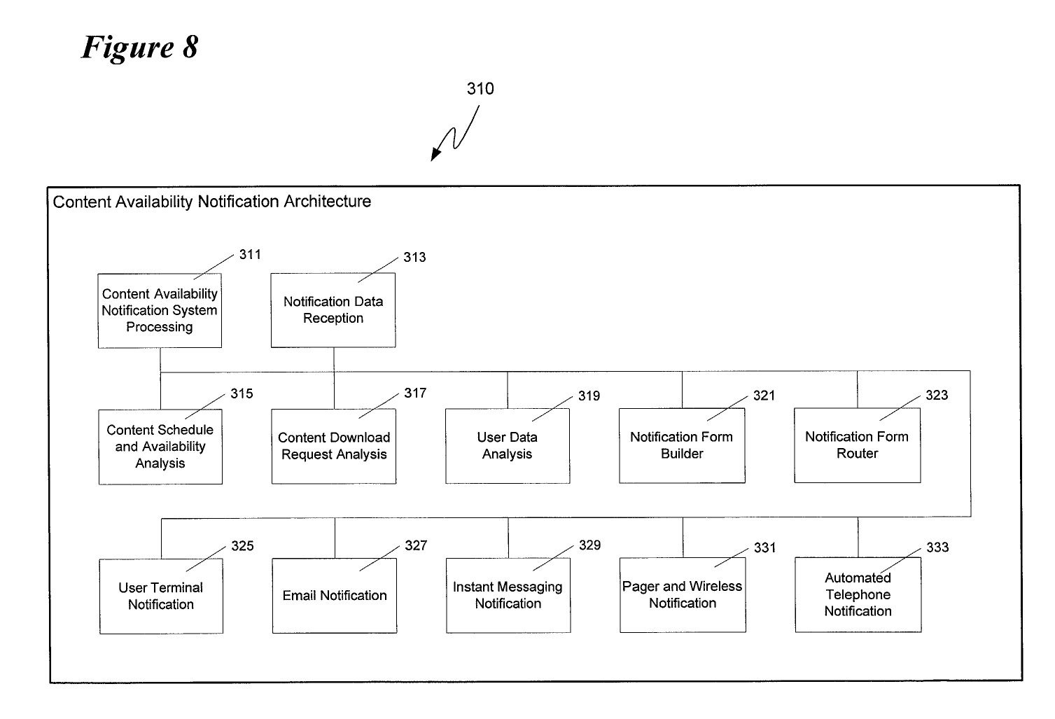

FIG. 8 is a diagram of processing modules comprising a content availability notification architecture 310 that may reside in one or more components of a content availability notification processor 306 shown in FIG. 5, and may control operations of the content availability notification processor 306. The content availability notification architecture 310 includes a content availability notification system processing module 311 that is coupled to one or more other processing modules within the content availability notification method 310 and that may manage the configuration and operation of one or more other processing modules within the content availability notification architecture 310. The notification system processing module 311 may also be operably connected to and may communicate and interact with other systems of the aggregator 201 including, but not limited to a system administrator 500 and a communications server 250 as well as a content download request processor 302 within the request and results processing server 300. In an embodiment, the processing modules within the content availability notification architecutre 310 may be interconnected using a bus topology that may allow dynamic interconnectivity between up to all of the processing modules and may support logical addressing of modules for communications routing.

The notification system processing module 311 may be coupled to a notification data reception module 313 that may communicate with one or more system components that may include the content download request processor 302 and the aggregator system administrator 500 to receive notification data. Notification data refers to data that may be used to formulate and transmit one or more content availability notification messages to one or more system users and may include, but is not limited to, information contained within a system user's content download request, information contained in a system user's profile and history, and information concerning the scheduling, availability, and source location and/or address of content requested for download and/or delivery. The notification data reception module 313 may be coupled to one or more data analysis modules including a content scheduling and availability analysis module 315, a content download request analysis module 317, and a user data analysis module 319 to which the data reception module 313 may forward notification data based on the source and/or type of data. The analysis performed by these modules may include logging of user information, verification of user authorization, identification of requested content schedule and/or sources, and creation and distribution of a list of tasks required to fulfill the notification method 310.

The content schedule and availability analysis module 315 may operate on schedule and availability data forwarded by the system administrator 500 from the content acquisition server 400 and/or the content delivery server 450 in response to a user content download request. The download request may contain data from the original content search request results that may indicate that the requested content may be available from one or more local sources or remote sources. For content that may be available from remote sources, the content acquisition server 400 may access data that may have been assembled earlier during a response to a user content search request and that describes the times of and locations from which desired content may be available as well as pertinent routing information that may be required for the user to access the content, such as a cable television channel number for viewing video programming or a network address for content download. For content that may be available from local sources, the content delivery server 450 may access similar data about local content that may include scheduling and/or local storage 254 addressing information. A user download request may serve to request one or more programs and/or content downloads per the system user's selection from search results, and therefore the schedule and availability data may include one or more listings of time and location for one or more desired programs and/or content downloads. The schedule and availability analysis module 315 may query the source of requested content and may verify various criteria such time of availability, speed at which content may be downloaded, and/or source location or address. The schedule and availability analysis module 315 may then route processed schedule and availability data to a notification form builder 321 for further processing. Availability data may also include billing information for one or more requested downloads and this data may be forwarded to the notification form builder 321 for inclusion in the notification form to inform the system user of any fees or charges that may be incurred by accepting content for delivery.

The content download request analysis module 317 may operate on data contained within the user's content download request that may be pertinent for formatting and routing one or more content availability notification forms such as identification of requested content, user terminal address, user identification, and current user notification preferences. The request analysis module 317 may extract such data from a user content download request and forward that data to a notification form builder 321 for further processing.

The user data analysis module 319 may operate on data contained in a system user's history and/or profile information maintained by the system administrator 500. The user data analysis module 319 may analyze and/or extract data from a user's profile such as data concerning availability notification preferences and forward this data to the notification form builder 321 for further processing. In an embodiment, a user may define certain parameters that may govern the method of availability notification such as the target system for receiving notification and the form of the notification. Notification preferences in a user's profile may be used as default settings and preferences included within a specific download request may be able to override and/or change these default settings. For example, a user profile may contain default notification settings that prompt the availability notification architecture 310 to send notification to the user terminal 202 for display on-screen, however in a particular download request, the system user may be able to designate a different and/or additional notification method such as by email or telephone. The user profile may also contain preferences that govern the format that a notification should take and preferences that define what data the user wishes to be displayed as part of the notification. For example, the user may have chosen that an on-screen notification should take the form of a pop-up message that gives the content title, type, time, and source channel. In an embodiment, notification preferences may reside within the user terminal 202 so that final processing and presentation formatting of a notification form may take place within the user terminal 202 using notification data sent by the content availability notification processor 306.

In an embodiment, the notification system processing module 311 may receive instructions for advertising from other aggregator 201 components such as the system administrator and may forward this data to the notification form builder 321 for inclusion in the notification form. Advertising may comprise static or dynamic on-screen advertisements, audio advertisements, banner advertisements in email and/or other wireless system notification forms. In an embodiment, the advertising data include in an availability notification prompt may take the form of placeholders where the actual advertising content may have been downloaded to a user terminal at an earlier time.

A notification form builder 321 may receive data from one or more data analysis modules for inclusion in one or more content availability notification forms to be sent to one or more user terminals 202 and/or other notification devices to notify a user of availability of programming and/or content downloads designated in one or more content download requests. The notification form builder 321 may use content scheduling and availability data to populate one or more electronic availability notification forms with programming, scheduling, availability, and content source information for transmission to one or more system users. The notification form builder may forward one or more electronic notification forms to a notification form router 323.

The notification form router 323 may receive one or more content availability notification forms, analyze user identification, addressing, and notification preference data, and route the forms to one or more notification modules for transmission to one or more system users. The one or more notification modules to which notification forms may be routed may be determined by user preferences that may designate one or more forms for the availability notification. Notification forms may include, but are not limited to, transmission to a user terminal 202 for presentation by a video display system 207, an audio playout system 208, user input devices 214, and/or an electronic book reader 230, transmission of an electronic mail message and/or instant text message to one or more devices such as a personal computer terminal 211, an electronic book reader 230, a handheld computer or personal digital assistant, an electronic pager, and/or a mobile telephone and/or other wireless device capable of receiving and displaying electronic mail and/or instant text messages. In an embodiment, the notification form may be encrypted prior to transmission to protect user-specific data that may be contained within the form.

If it is indicated in the system user's profile and/or a current content download request that the content availability notification should be sent to the user terminal 202, then the notification form router 323 may forward the notification form to a user terminal notification module 325. The user terminal notification module 325 may receive one or more notification forms from the notification form router 323 and may analyze data delivery requirements for one or more system users and forward notification forms to the communications server, which may determine the appropriate channels within the wide area distribution system 203 that may be used to transmit the notification forms to the intended system terminals. Channels within the wide area distribution system 203 that may be used include, but are not limited to, Internet and other digital protocol systems that may operate over coaxial cable, optical fiber, and/or twisted pair wireline networks, off-air television and radio broadcast systems, satellite communications systems, and other wireline and/or wireless transmission systems that may support communications between an aggregator system 201 and one or more user terminals 202. The target user terminal 202 may receive, decrypt, and store the notification form in the user local database 213 and then take action to inform the system user of the reception and/or the contents of the content availability notification form.

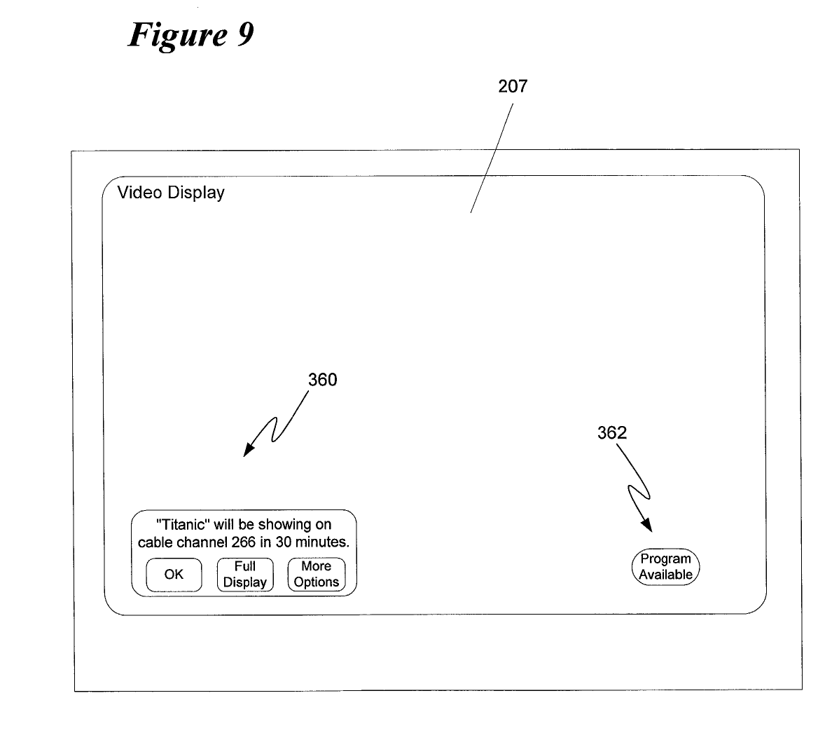

The method by which the user terminal 202 informs the system user that one or more content availability notification forms have been received may take one or more of several forms that may be determined by system user preferences and/or historical data concerning a system user's method of accessing prior notification information. In an embodiment, a pop-up notification window 360, or message, containing notification of program availability may appear in a portion of the video display system 207 and may display a subset of the data contained in the notification form, such as the content title and/or time the content may be delivered. In another embodiment, a small notification icon 362 may be displayed on the screen of a video display system 207 that may indicate that a notification form is available for display. In yet another embodiment, an audible notification may be played through the audio playout system 208 that may comprise a prerecorded sound file and/or an artificially generated voice message that may read out information contained in the notification form. Examples of a video pop-up notification window 360 and a video notification icon 362 are shown in FIG. 9. In an embodiment, the icon 362 may flash or periodically change appearance to draw user attention or may be semitransparent and be overlaid over the current video display, likely in a lower corner as shown in FIG. 9. The user may then respond to the icon 362 and/or the pop-up window 360 in a manner such as using an on-screen cursor or depressing an acknowledgment and/or display button on one or more user input devices 214. In an embodiment, a user's response to the pop-up window 360 and/or icon 362 may discontinue the display of the window or icon for either later viewing of content availability notification, and/or may instruct the user terminal 202 to connect to the content source. The pop-up window 360 may also include options that may prompt the user terminal 202 to display additional data that may include one or more data items from the notification form and/or items from the content metadata that may have been part of the search results form from which the user selected the content for delivery and may include a selection to display further notification options.

In an embodiment, upon receipt of availability notification data, a user terminal 202 may transmit a signal to one or more user input devices 214 that may initiate visual and/or audible indication on one or more of the user input devices 214 indicating receipt of notification data. Visual indication on a user input device 214 may take the form of an illuminated LED and/or an message or icon that may be displayed on an LCD or other type of display screen that may be integrated into one or more of the user input devices 214. The user may then respond to the indication in a manner such as depressing an acknowledgment button and/or display button and/or touching a touch-screen on the user input device 214. Audible notification may take the form of a periodic tone or beeping that alerts the user to the receipt of content availability notification.

If the system user's profile and/or a current content download request indicates that the content availability notification should be sent as an electronic mail, or email, message, then the notification form router 323 may forward a notification form to an email notification module 327. The email notification module 327 may receive one or more notification forms from the notification form router 323 and may analyze data delivery requirements for one or more system users and may create one or more automated email messages containing notification data. The email notification module 327 may send one or more email notifications of content availability to one or more systems users using one or more standard delivery protocols such as the simple mail transfer protocol (SMTP) and post office protocol (POP) using one or more TCP/IP connections through one or more channels of a wide area distribution system 203 and/or the Internet. Based on the email addressing information provided by a system user, the email notification module 327 may send the notification message to one or more of a personal computer terminal, a handheld computer, an electronic book reader, a mobile telephone, or other device capable of receiving and rendering an email message. The email notification message may contain data that identifies the requested content, indicates a schedule of availability, and identifies the source of content. In an embodiment, the email notification may contain a hyperlink that may activate one or more software routines to retrieve and/or display the requested content.

If the system user's profile and/or a current content download request indicates that the content availability notification should be sent as an instant electronic message, then the notification form router 323 may forward a notification form to an instant messaging notification module 329. The instant messaging notification module 329 may receive one or more notification forms from the notification form router 323 and may analyze data delivery requirements for one or more system users and may create one or more instant text messages containing notification data. The instant messaging notification module 329 may send one or more availability notification messages to one or more systems users using one or more standard and/or proprietary delivery protocols and/or delivery and display software routines. Instant messaging notification may be transmitted to one or more terminals and/or devices capable of receiving and displaying instant text messages such as a personal computer terminal, a handheld computer, an electronic book reader, and/or a mobile telephone. The instant messaging notification may contain data that identifies the requested content, indicates a schedule of availability, and identifies the source of content. In an embodiment, the instant messaging notification may contain a hyperlink that may activate one or more software routines to retrieve and/or display the requested content.

If the system user's profile and/or a current content download request indicates that the content availability notification should be sent as an electronic paging message, then the notification form router 323 may forward a notification form to a pager and wireless notification module 331. The paging and wireless notification module 331 may receive one or more notification forms from the notification form router 323 and may analyze data delivery requirements for one or more system users and may create one or more paging messages containing notification data. The paging and wireless notification module 329 may send one or more availability notification messages to one or more systems users using one or more standard and/or proprietary delivery protocols and/or delivery and display software routines and may send these paging messages via one or more paging networks that may use satellite and/or other wireless network distribution systems. Paging notification may be transmitted to one or more terminals and/or devices capable of receiving and displaying paging text messages such as and electronic paging unit, a handheld computer, and/or a mobile telephone. The paging notification may contain data that identifies the requested content, indicates a schedule of availability, and identifies the source of content.

If the system user's profile and/or a current content download request indicates that the system user desires to be notified of available content by telephone, then the notification form router 323 may forward a notification form to an automated telephone notification module 333. The telephone notification module 333 may receive one or more notification forms from the notification form router 323 and may analyze data delivery requirements for one or more system users and may initiate one or more automated telephone calls to one or more telephone numbers. The automated telephone notification may consist of a prerecorded and/or artificially generated voice message that may contain data that identifies the requested content, indicates a schedule of availability, and identifies the source of content. In an embodiment, automated telephone notifications may comprise an automated menu system accessible with a touchtone phone to offer system users options related to content availability and/or delivery.

Regardless of the notification methods used to alert a system user of the availability of requested content, there may be various delivery options associated with a content availability notification. These delivery options may be entered by a system user into that user's profile that may be stored in the user terminal 202 and/or the aggregator 201, may be entered by a system user as part of a content download request, and/or may be activated using options made available with the notification itself. For example, a user may have entered into the user profile to be notified of available content by email three hours prior to the scheduled time of a particular program, however while initiating a certain download request, that user may designate to be notified one hour in advance by an on-screen pop-up window 360, at which time the user may activate an option to remove the pop-up window 360 and have the user terminal 202 display an icon 362 periodically until the program becomes available, at which time the user terminal may tune automatically to the appropriate channel to receive the desired content. In an embodiment, notification may occur at certain times prior to the content being available such as if an on-screen pop-up window 360 is displayed for a short time one hour prior to content availability and then an icon 362 is displayed for a brief period at various intervals such as thirty minutes, ten minutes, and five minutes prior to content availability, and ultimately at the program availability time.

1. A computer readable medium, having programming executable on a computer, that provides program content notification related to content available on a video and multimedia program content distribution network, comprising:
a content availability notification module;
a notification data reception module, coupled to the content availability notification module, that receives and processes notification data, wherein the notification data is used to formulate and transmit one or more content availability notification messages;
a content schedule and availability analysis module, coupled to the notification data reception module, that receives and processes one or more of content schedule and availability of the program content available on the video and multimedia program content distribution network and user content download requests, and produces processed schedule and availability data;
a content download request analysis module, coupled to the notification data reception module, that processes data from the user download requests for formatting and routing one or more content notification availability forms;
a notification form builder, coupled to the content schedule and availability analysis module, that receives the processed schedule and availability data, and generates a notification form;
a notification form router, coupled to the notification form builder, that routes notification data for transmission to a user; and
one or more notification modules that provide the program content notification.

2. The computer readable medium of claim 1, wherein the one or more notification modules comprise:
a user terminal notification module that provides an on-screen notification;
an email notification module that provides an email notification;
an instant messaging notification module that provides an instant text notification message;
a pager and wireless notification module that provides one of a voice and a text notification message; and
an automated telephone notification module that provides a telephone message notification.

3. The computer readable medium of claim 2, wherein the on-screen notification includes one or more of an on-screen pop up window, an on-screen banner, an icon, and an audible message.

4. The computer readable medium of claim 3, wherein the on-screen notification is provided at one of a television and an computer display.

5. The computer readable medium of claim 4, wherein the on-screen notification includes a hyperlink to one or more programs.

6. The computer readable medium of claim 1, wherein the program content notification is provided until an acknowledgement is received by the content availability notification module.

7. The computer readable medium of claim 6, wherein the program content notification is provided continually.

8. The computer readable medium of claim 6, wherein the program content notification is provided periodically.

9. The computer readable medium of claim 1, wherein the one or more notification modules provide the program content notification

10. The computer readable medium of claim 1, further comprising a user data analysis module, coupled to the notification data reception module, that receives and processes user profile data.

11. The computer readable medium of claim 1, wherein the notification data are contained in a program content download request.

12. The computer readable medium of claim 1, further comprising a user's profile and history file, wherein the notification data are contained in the user's profile and history file.

13. The computer readable medium of claim 1, wherein the notification data includes the method of delivery of the program content notification.

14. A method for notifying users of availability of video and digital multimedia program content in a video and multimedia program content distribution network, comprising:
receiving a program content request, wherein the request specifies desired program content for delivery to a user terminal;
receiving information related to availability of the desired program content;
determining a notification protocol to notify the user terminal of the availability of the desired program content;
analyzing the information related to the availability of the desired program content;
generating a notification form; and
routing the notification form to one or more notification modules, wherein the one or more notification modules transmit a program content availability notification.

15. The method of claim 14, wherein the step of determining the notification protocol comprises analyzing a user history and profile file.

16. The method of claim 14, wherein the step of determining the notification protocol comprises analyzing a program content download request.

17. The method of claim 14, wherein the notification protocol comprises one or more of delivery of an on-screen prompt, an email message, a wireless message, an instant text message, an audio message, and an automated telephone message.

18. The method of claim 14, further comprising repeating the program content availability notification until an acknowledgement is received.

19. The method of claim 18, wherein the acknowledgement is received at the user terminal.

20. A system that provides program content notification related to content available on a video and multimedia program content distribution network, comprising:
means for receiving program notification data, wherein the receiving means receives and processes notification data, wherein the notification data is used to formulate and transmit one or more content availability notification messages;
means for analyzing program content schedule and availability, coupled to the receiving means, wherein the means for analyzing program content schedule and availability receives and processes one or more of content schedule and availability of the program content available on the video and multimedia program content distribution network and user content download requests, and produces processed schedule and availability data;
means for analyzing a program content download request, coupled to the receiving means, wherein the means for analyzing a program content download request processes data from the user download requests for formatting and routing one or more content notification availability forms;
means for generating a notification form, coupled to the means for analyzing content schedule and availability, wherein the generating means receives the processed schedule and availability data, and generates a notification form;
means for routing the notification form, coupled to the generating means, wherein the routing means routes notification data for transmission to a user; and
means for providing the program content notification.

21. The system of claim 20, wherein the means for providing the program content notification comprises:
means for providing an on-screen notification;
means for providing an email notification;
means for providing an instant text notification message;
means for providing a wireless voice and a text notification message; and
means for providing an automated telephone message notification.

22. The system of claim 21, wherein the on-screen notification includes one or more of an on-screen pop up window, an on-screen banner, an icon, and an audible message.

23. The system of claim 22, wherein the on-screen notification is provided at one of a television and an computer display.

24. The system of claim 23, wherein the on-screen notification includes a hyperlink to one or more programs.

25. The system of claim 20, wherein the program content notification is provided until an acknowledgement is received by the receiving means.

26. The system of claim 25, wherein the program content notification is provided continually.

27. The system of claim 25, wherein the program content notification is provided periodically.

28. The system of claim 20, further comprising means of analyzing user data, coupled to the receiving means, wherein the means for analyzing user data receives and processes user profile data.

29. The system of claim 20, wherein the notification data are contained in a program content download request.

30. The system of claim 20, further comprising a user's profile and history file, wherein the notification data are contained in the user's profile and history file.

31. The system of claim 20, wherein the notification data includes the method of delivery of the program content notification.
